(19) United States
(12) Patent Application Publication
(10) Pub. No.: US 2017/0247911 A1
(43) Pub. Date: Aug. 31, 2017

(54) DOOR ACTUATING ASSEMBLIES FOR ANIMALS

(71) Applicants: James Edward LEE, JR., Saint Leonard, MD (US); James Edward LEE, SR., Saint Leonard, MD (US); Richard Elmo LEE, JR., Saint Leonard, MD (US)

(72) Inventors: James Edward LEE, JR., Saint Leonard, MD (US); James Edward LEE, SR., Saint Leonard, MD (US); Richard Elmo LEE, JR., Saint Leonard, MD (US)

(21) Appl. No.: 15/056,975

(22) Filed: Feb. 29, 2016

(51) Int. Cl. E05B 1/00; E05F 1/00; E05B 63/18

(52) U.S. Cl. CPC E05B 1/0053; E05B 1/0015; E05B 63/185; E05F 1/00

(57) ABSTRACT

Door actuating assemblies for animals are provided herein. An apparatus includes a latch bolt covering member that is configured cover a latch bolt to prevent the latch bolt from engaging with a strike plate aperture in a door frame of the door, and a door knob that is attachable to a lower portion of the door for use by a pet.

### FIELD OF THE PRESENT DISCLOSURE

Embodiments are directed to apparatuses for animals, and more specifically, but not by limitation, to assemblies that allow an animal, such as a dog, to easily open a door using an appendage.

### SUMMARY

According to some embodiments, the present disclosure is directed to an apparatus, comprising: (a) a latch bolt member that is configured to cover a latch bolt to prevent the latch bolt from engaging with a strike plate aperture in a door frame of the door; and (b) a door knob that is attachable to a lower portion of the door for use by a pet.

According to some embodiments, the present disclosure is directed to a assembly, comprising: (a) means for preventing a latch bolt of a door from engaging with a strike plate aperture in a door frame of the door; (b) a door knob that is attachable to a lower portion of the door for use by a pet; and (c) a door armature that automatically returns the door to a close configuration when the door knob is not being pulled and the door is in an open configuration.

According to some embodiments, the present disclosure is directed to a assembly, comprising: (a) a latch bolt covering member that is configured to mount onto a door and cover a latch bolt to prevent the latch bolt from engaging with a strike plate aperture in a door frame of the door; (b) a strike plate plug that fills a strike plate aperture; (c) a door knob that is attachable to a lower portion of the door for use by a pet; and (d) a door armature that automatically returns the door to a closed configuration when the door knob is not being pulled and the door is in an open configuration.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1A is a perspective of an apparatus constructed in accordance with the present disclosure, for use with a door;

FIG. 1 B is a partial cross-sectional side view showing the latch bolt covering member configured for use on the door shown in FIG. 1A;

FIG. 2 is a perspective view of an example latch bolt covering member;

FIG. 3 is a perspective view of an example removable and replaceable lower door knob with a replaceable plate;

FIG. 4 is a perspective view of another example lower door knob that can be joined to a side edge or lower edge of a door;

FIG. 5 is a perspective view of another example latch bolt member in the form of a plug that fills a strike plate aperture and cavity;

FIG. 6 is a perspective view of an example spacer device, for use with an apparatus of the present disclosure and

FIG. 7 is a cross sectional view of FIG. 6.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

In general, the present disclosure is directed to assemblies that allow an animal to open a door with an appendage, such as a paw. The assemblies can include sub-assemblies that prevent the door from latching, as well as door knob sub-assemblies that allow the animal to pull the door open. In some embodiments, the present disclosure includes a door armature sub-assembly that closes the door after the animal has opened the door.

Some embodiments include selectively positionable door knobs, one or more types of latch bolt covers, and various combinations thereof.

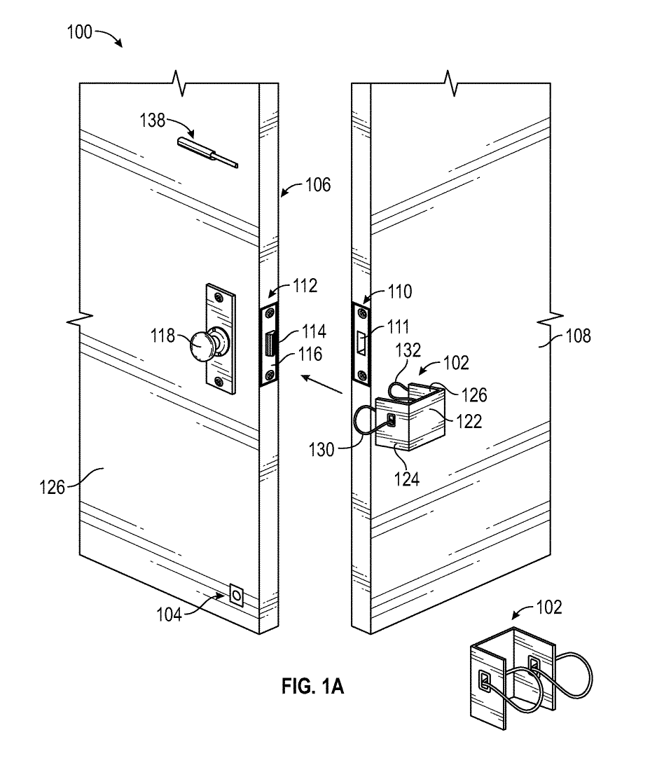

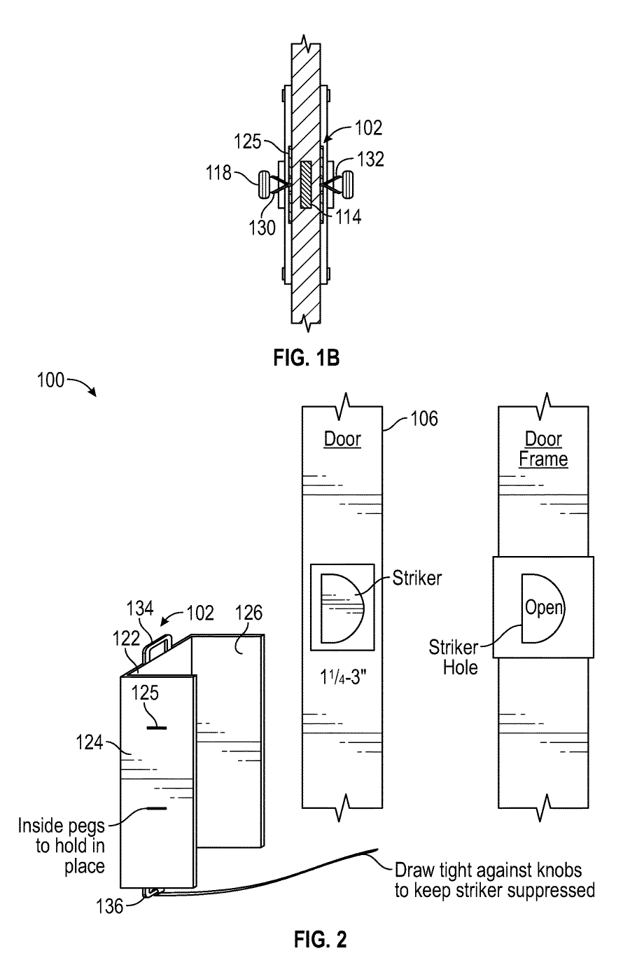

FIG. 1 illustrates an example apparatus 100 that comprises a latch bolt member 102 and a lower door knob 104. The assembly 100 is installed onto a door 106. The apparatuses of the present disclosure can be utilized on any door. The door 106 is installed within a door frame 108 that comprises a strike plate 110 having a strike plate aperture 111. The strike plate 110 is aligned with a latch assembly 112 installed onto a side edge of the door 106. The latch assembly 112 comprises a latch bolt 114 that extends from a face plate 116. When a user rotates either a front knob 118 or a rear knob 120, the latch bolt 114 extends from or recesses behind the face plate 116.

A neutral position of the latch bolt 114 is to extend past the face plate 116. When the door 106 is closed the latch bolt 114 is disposed within the strike plate aperture 111 of the strike plate 110, securing the door 106 relative to the door frame 108.

To allow the door 106 to open freely by use of the lower door knob 104, the latch bolt member 102 is used to cover the latch bolt 114. Thus, regardless of a rotated position of the front knob 118 or the rear knob 120, the door 106 can close into the door frame 108 while remaining disengaged from the strike plate 110 such that the door 106 can be opened with the lower door knob 104, front knob 118 or rear knob 120, without being required to turn the selected knob.

In some embodiments, the latch bolt member 102 comprises a u-shaped channel that comprises a latch bolt covering plate 122 and two flange plates 124 and 126 that extend from the latch bolt covering plate 122. The two flange plates 122 and 124 can mate with a front surface 126 of the door 106 and a rear surface 128 of the door 106, respectively.

To be sure, the latch bolt member 102 acts as a clamp that covers the side edge of the door 106. In some embodiments, the latch bolt member 102 comprises two loops 130 and 132 that secure around the front knob 118 and rear knob 120, respectively. The loops can be constructed from drawstrings, zip-ties, elastic bands, or similar materials. The loops wrap around the base (or stem) of their respective door knobs.

In one embodiment, such as in FIG. 2, the latch bolt member 102 can include loops 134 and 136 that extend from the latch bolt covering plate 122 rather than the two flange plates 124 and 126. In one embodiment, the two flange plates 124 and 126 can each comprise one or more protrusions or pegs 125 that hold the two flange plates 124 and 126 in place on the door 106.

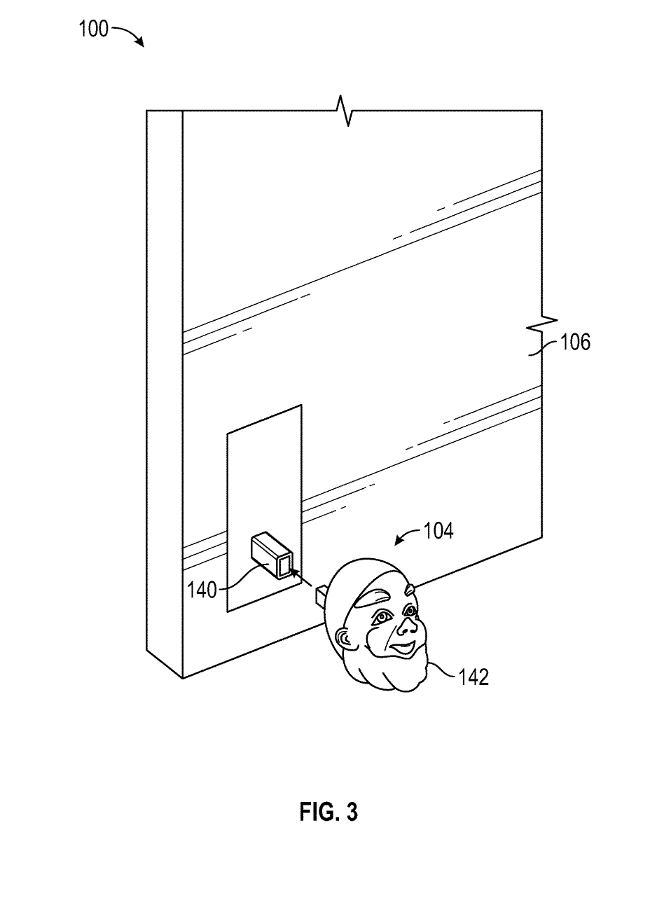

In FIG. 3, the lower door knob 104 is configured for use by an animal. The animal can grab the lower door knob 104 with their appendage and open the door 106. The lower door knob 104 can comprise a shaft 140 and a plate 142 disposed on a terminal end of the shaft 140. The plate 142 can be selectively removed and replaced in some embodiments. The plate 142 can also comprise a decorative pattern or ornamental design, such as but not limited to for example a garden gnome ornament or a horse shoe shaped ornament, that allows the animal to easily grab the plate 142 with their paw.

In one embodiment, the lower door knob 104 can be permanently affixed to a lower portion of the door 106, as illustrated in FIG. 1. In other embodiments, the lower door knob 104 can be releaseably secured to the door 106, as with the door knob embodiment in FIG. 3.

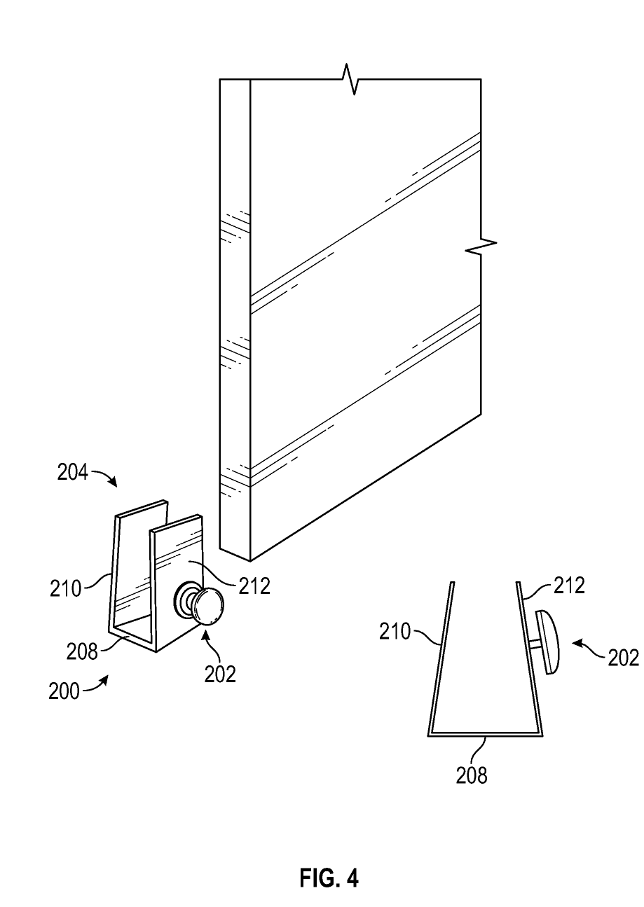

In FIG. 4, an example lower door knob 200 is illustrated that comprises a door knob 202 that is associated with a mounting bracket 204. In some embodiments, the mounting bracket 204 comprises a channel 208 with flanges 210 and 212. In one embodiment the door knob 202 extends normally from one of the flanges, such as flange 210. The flange selected can include the flange that is positioned on a face of the door that opens outwardly when the animal engages the door knob 202. The opposing face of the door, in contrast, is pushed by the animal to open, rather than pulling with a paw.

In one embodiment, the mounting bracket 204 compressively engages with a side edge or lower edge of a door because the flanges 210 and 212 are spaced apart from one another but angled inwardly towards one another.

Referring back to FIG. 1, in some embodiments, the apparatus 100 can comprise a door armature 138 that selectively closes the door when the door 106 is open. For example, the door armature 138 can selectively close the door 106 after the animal has opened the door 106 and passed through the door opening. An example door armature 138 can include a pneumatic cylinder actuated arm, which gently closes the door 106 after opening. Other similar devices can be used to close the door 106 after use.

In general, the door armature 138 automatically returns the door to a closed configuration when the door knob is not being pulled and the door is in an open configuration, such as when the door is not at rest within the door frame.

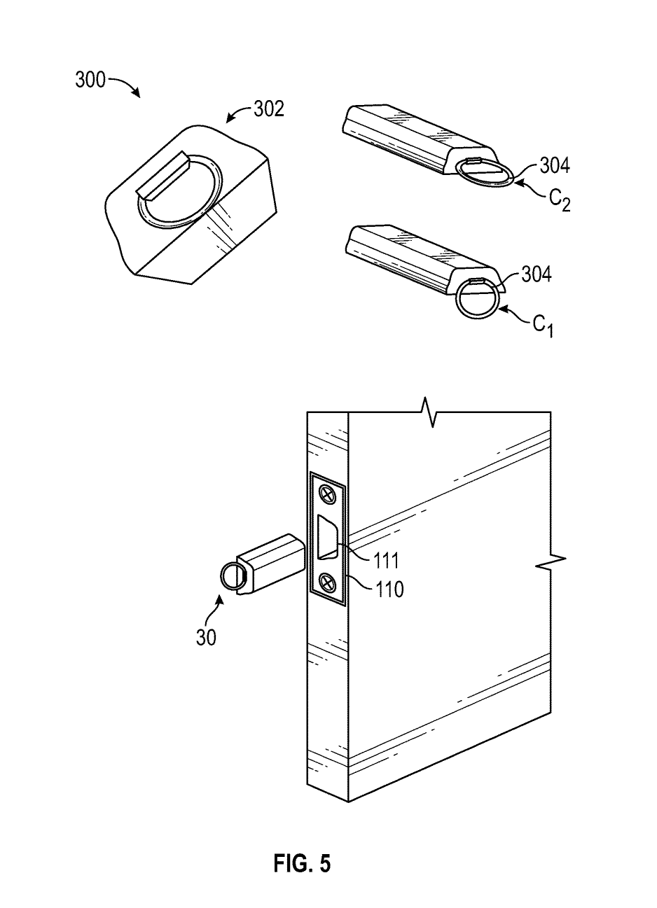

FIGS. 1 and 5 collectively illustrate an alternative embodiment of a latch bolt member 300 that comprises a plug 302. In some embodiments, the plug 302 fits within a strike plate aperture 111 of the strike plate 110 through which the latch bolt 114 extends. A body of the plug 302 is configured to fill the strike plate by insertion through the strike plate aperture 111. The plug 302 can be used alone, or in combination with the latch bolt member 102 of FIG. 1.

The plug 302 prevents the latch bolt 114 from extending into the strike plate 110 by preventing the latch bolt 114 from sliding into the strike plate aperture 111.

In some embodiments, the plug 302 comprises a pivoting ring 304 that extends between a collapsed configuration C₁ that allows the door 106 to close into the door frame 108 and a deployed configuration C₂ that allows a user to remove the plug 302 from the strike plate aperture 111.

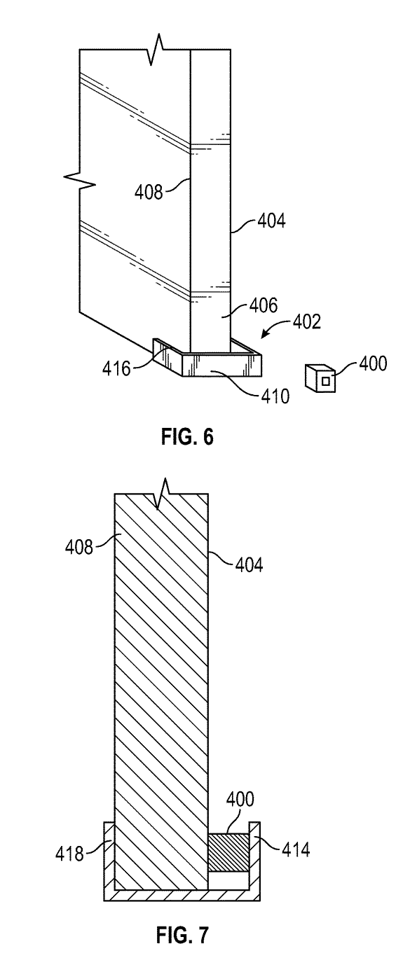

FIGS. 6 and 7 collectively illustrate a spacer 400 that can be utilized to allow an apparatus 402 of the present disclosure to be joined with doors having various thicknesses, where the thickness is measured from a front surface 404 of a door 406 to a back surface 408 of the door 406.

The apparatus 402 comprises a u-shaped channel 410 that mounts to the underside of the door 406. The spacer 400 fills a gap 412 that is created between a flange 414 of the channel 410 and a door surface, such the front surface 404. A knob 416 can be mounted to an opposing flange 418 of the channel 410. A plurality of spacers can be utilized in some embodiments.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/ or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. An assembly, comprising:
a latch bolt member that is configured to cover a latch bolt to prevent the latch bolt from engaging with a strike plate aperture in a door frame of the door; and
a door knob that is attachable to a lower portion of the door for use by a pet.

2. The assembly according to claim 1, wherein the latch bolt member comprises a u-shaped channel that comprises a latch bolt covering plate and two flange plates that extend from the latch bolt covering plate, the two flange plates mating with a front surface of the door and a rear surface of the door.

3. The assembly according to claim 2, further comprising a loop associated with at least one of the two flange plates, the loop being configured to secure around a door knob of the door.

4. The assembly according to claim 2, further comprising a pair of loops associated with the two flange plates, the pair of loops comprising a front loop that secures around a front door knob of the door and a rear loop that secures around a rear door knob of the door.

5. The assembly according to claim 2, further comprising a loop associated with the latch bolt covering plate, the loop being configured to secure around a door knob of the door.

6. The assembly according to claim 1, wherein the latch bolt member comprises a plug that fits within a strike plate aperture of a strike plate of the door frame.

7. The assembly according to claim 6, wherein the plug comprises a pivoting ring that extends between a collapsed configuration that allows the door to close into the door frame and a deployed configuration that allows a user to remove the plug from the strike plate aperture.

8. The assembly according to claim 1, wherein the door knob is associated with a mounting bracket that comprises a channel with flanges, the door knob extending normally from one of the flanges.

9. The assembly according to claim 8, wherein the mounting bracket compressively engages with a side edge or lower edge of the door because the flanges are spaced apart but angled inwardly towards one another.

10. The assembly according to claim 1, wherein the door knob comprises a shaft and a plate, the plate being configured to allow the pet to utilize a paw to open the door.

11. The assembly according to claim 1, wherein the plate is removable and replaceable.

12. An assembly, comprising:
means for preventing a latch bolt of a door from engaging with a strike plate aperture in a door frame of the door;
a door knob that is attachable to a lower portion of the door for use by a pet; and
a door armature that automatically returns the door to a closed configuration when the door knob is not being pulled and the door is in an open configuration.

13. An assembly, comprising:
a latch bolt covering member that is configured to mount onto a door and cover a latch bolt to prevent the latch bolt from engaging with a strike plate aperture in a door frame of the door;
a strike plate plug that fills a strike plate aperture;
a door knob that is attachable to a lower portion of the door for use by a pet; and
a door armature that automatically returns the door to a closed configuration when the door knob is not being pulled and the door is in an open configuration.

14. The assembly according to claim 13, wherein the door knob is associated with a mounting bracket that comprises a channel with flanges, the door knob extending normally from one of the flanges.

15. The assembly according to claim 14, wherein the mounting bracket compressively engages with a side edge or lower edge of the door because the flanges are spaced apart but angled inwardly towards one another.

16. The assembly according to claim 15, wherein one or more of the flanges comprise one or more protrusions or pegs that engage with front or back surfaces of the door.
